(19) United States
(12) Patent Application Publication
(10) Pub. No.: US 2008/0196827 A1
(43) Pub. Date: Aug. 21, 2008

(54) Fabrication of Electronic Components In Plastic

(75) Inventors: David Victor Thiel, Queensland (AU); Neeli Madhusudanrao, Queensland (AU)

Correspondence Address: CONNOLLY BOVE LODGE & HUTZ LLP, 1875 EYE STREET, N.W., SUITE 1100, WASHINGTON, DC, 20036, US

(73) Assignee: Griffith University, Queensland (AU)

(21) Appl. No.: 11/994,698

(22) PCT Filed: Jul. 3, 2006
(86) PCT No.: PCT/AU2006/000926

§ 371 Date: Jan. 4, 2008

(30) Foreign Application Priority Data
Jul. 4, 2005 (AU) 2005903514

(51) Int. Cl. B32B 37/12; B32B 37/00

(52) U.S. Cl. 156/272.8; 156/281; 156/277; 156/384; 156/349; 156/500

(57) ABSTRACT

A method of forming electronic components in which a thermoplastic substrate is embossed to create a recess for electronic components; the electronic component is placed in the recess; electrical connections and circuitry are deposited over the components on the thermoplastic substrate; and a cover sheet of thermoplastic material is bonded over the circuitry. The process may also be carried out in reverse order. The apparatus used consists of a hot embossing machine having a former shaped for each particular circuit to be assembled; a pick and place machine with standard reel loading of components; and a screen printer for printing the conductive ink circuitry or a station for adhering conductive tape or preprinted film.

This invention relates to the manufacture of electronic circuits using components embossed in a plastic substrate instead of conventional printed circuit boards.

### BACKGROUND OF THE INVENTION

Electronic devices are traditionally made on a printed circuit board (PCB) where devices such as chips adhered to the substrate and are connected by metal tracks deposited onto the substrate.

For some applications there is a need to encase the electronic components in a protective package. Recent guidelines in Europe require use of lead free techniques in electronics assembly which means alternatives to solder are needed.

Standards also require the use of recycled or recyclable plastics and biodegradable plastics.

Polycarbonate is a material used in electronics and microfluidic devices but a method for using it in packaging electronic components has not been developed.

One possibility is to encase the components in the polycarbonate but most embossing machines are manually operated and pressure and temperature and other variables cannot be controlled uniformly. The brittle nature of the materials also adds to the difficulty of controlling the process.

It is an object of this invention to provide a method and apparatus for embedding and connecting electronic components in plastic materials that conform with environmental guidelines.

### BRIEF DESCRIPTION OF THE INVENTION

To this end the present invention provides a method of forming electronic circuits in which
a) a thermoplastic substrate is embossed or machined to create one or more recesses for one or more electronic components
b) electronic components are placed in the recesses
c) electrical connections and circuitry are deposited over the components on the thermoplastic substrate
d) bonding a cover sheet of thermoplastic material over the circuitry.

In an alternative embodiment the procedure is
a) a thermoplastic substrate is embossed or machined to create one or more recesses for the electronic components
b) one or more electronic components are placed in the recesses
c) electrical connections and circuitry are deposited on a thermoplastic backing sheet
d) the embossed substrate is bonded to the backing sheet to complete the electrical connections between the components and the circuitry.

This process is applicable with most mouldable thermoplastics capable of being hot embossed. Preferably the plastics are biodegradable, recyclable and/or biocompatible. No chemical solvents or solders are used in the process and the circuit package is sealed.

The deposition of the circuitry may be by
a) screen printing of conductive inks
b) adhering conductive tapes
c) adhering a plastic film with the preprinted circuitry to the substrate.

More than one cover sheet may be used and printed with additional conductive tracks to create a multilayer circuit board. Some circuit components may be formed by printing different materials over the electrical connections to form active and passive circuit components.

The equipment required for carrying out this process is
a) a hot embossing machine having a former shaped for each particular circuit to be assembled
b) a pick and place machine with standard reel loading of components
c) and a screen printer for printing the conductive ink circuitry or a station for adhering conductive tape or preprinted film.

Instead of an embossing machine the recesses can be machined out of the plastics using any suitable technique including laser machining.

The circuits produced by this invention are ideal for low power circuits. Although the circuits are difficult to repair their sealed modular form makes them relatively easy to replace.

### DETAILED DESCRIPTION OF THE INVENTION

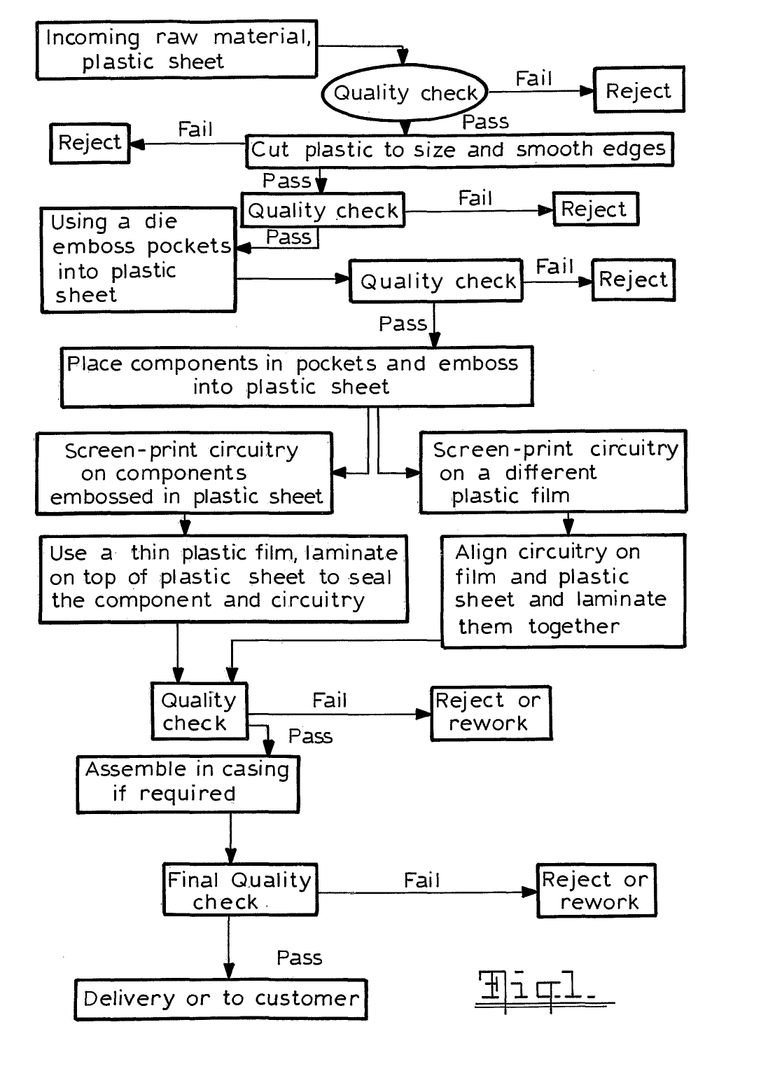

FIG. 1 illustrates a process flow chart according to this invention;

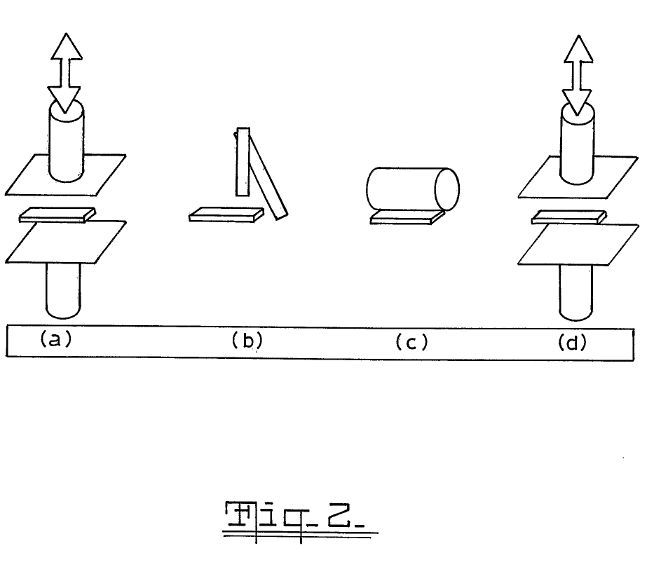

FIG. 2 is a schematic diagram of the process of this invention.

The hot embossing machine preferably uses a pneumatic press which is electrically regulated to control the applied pressure. The pressure plates incorporate embedded heating elements. A temperature controller controls the plate temperature with thermocouples and limits the activation of the system until the preset temperature settings are achieved.

The embossing is carried out in two stages
1) In stage 1, a die and substrate are aligned, held together and placed on the bottom plate
2) the top pressure plate contacts the die and substrate and preheats it to the set temperature
3) regulated pressure is then applied by the top plate to emboss pockets into the substrate.
4) The electronic components are then applied using a pick and place machine for correctly placing the components.
5) In stage 2, the components are embossed into the substrate using a thin cover sheet of the same plastic as the substrate.

As shown in FIG. 1 polycarbonate sheet is cut to size and the edges are smoothed. Pockets are pressed into the sheet as described above to accommodate the components.

Following the placement of the components the contacts and circuitry is screen printed onto the components and substrate using a flexible conductive ink. A laser cut steel shim is used as a mask for the conductive ink.

Alternatively the circuit is screen printed on a film and this is aligned with the contacts printed on the components in the substrate.

The assembled device is then returned to the hot embossing machine to adhere a cover sheet over the circuitry.

The total process is schematically shown in FIG. 2:

(a) Recesses are embossed into the plastic substrate

(b) A pick-and-place robot places the components into the holes

(c) Conductive tracks are printed onto the substrate

(d) The cover sheet is pressed onto the substrate to seal the circuit.

Bare silicon die has been successfully embossed in plastic and the electrical connections to the pads on the die have been made using screen printing.

To reduce the cost of printing circuit tracks and assembly reel to reel printers may be used.

Indicator lights can be enclosed in the plastic without the need to bring them to the surface as most plastics are translucent. Antennas can be printed and sealed as the material is highly insulating with very low loss (lower than standard fibreglass materials). EMC shielding can be incorporated using multiple layers of conductor covered material in the embossing process.

External electrical contacts for batteries etc can be made by allowing insulated wires or connector pins to protrude from the edge of the sealed package or placing through holes in the plastic cover sheet which will allow the conductive paste to flow into the next layer/surface. Multilayer boards can be made using this hole technique. Standard PCB design software can be used as the layouts are the same. The transfer of existing circuits to the new technology is therefore simple.

The conductive paste or ink is preferably flexible when dry to allow movement (eg stretching) during the hot embossing process. Flexible ink or paste is also needed when flexible plastic materials are used to produce flexible circuits. Some circuit components such as resistors, capacitors and sensing elements can be printed during this stage of the process.

The circuits may be manufactured in any shape—3D curved edge edges are possible using an external mould and custom designed jig during the embossing process.

The process of this invention reduces the volume of electronic goods by reducing the usual three layers of packaging (bare die, PCB, enclosure) to onein which bare die, encapsulated components and printed components can be included. The process can also be carried out in one facility.

The amount of waste generated in the process of this invention is much less than that produced in the standard solder reflow system and the wet/dry etch PCB technology.

This technique is applicable to small electronic devices that need to have the electronics isolated from the environment. They are particularly suitable for low power applications with low heat loss such as sensors used in watering systems, sports data loggers, internal medical monitoring devices and for microfluidic biological devices. The technology can be used for support electronics in microfluidics applications with the fluid channels being manufactured during the hot embossing and sealing process. The technology can be fully automated using reel-to-reel machines.

From the above, those skilled in the art will see that the present invention provides a low cost embossing and assembly process. Those skilled in the art will realize that this invention maybe implemented in embodiments other than those described without departing from the essential teachings of this invention.

1. A method of forming electronic circuits in which
a) a thermoplastic substrate is embossed to create one or more recesses for one or more electronic components
b) electronic components are placed in the recesses
c) electrical connections and circuitry are deposited over the components on the thermoplastic substrate
d) bonding a cover sheet of thermoplastic material over the circuitry.

2. A method of forming electronic devices in plastic in which
a) a thermoplastic substrate is embossed to create one or more recesses for the electronic components
b) one or more electronic components are placed in the recesses
c) electrical connections and circuitry are deposited on a thermoplastic backing sheet
d) the embossed substrate is bonded to the backing sheet to complete the electrical connections between the components and the circuitry.

3. A method as claimed in claim 1 in which the deposition of the circuitry is by
a) screen printing of conductive inks
b) adhering conductive tapes or
c) adhering a plastic film with the preprinted circuitry to the substrate.

4. A method as claimed in claim 1 in which some circuit components are formed by printing different materials over the electrical connections to form active and passive circuit components.

5. A method as claimed in claim 1 in which the thermoplastic substrate is heated and then embossed to form the recesses for the components.

6. A method as claimed in claim 1 in which the thermoplastic is a Polycarbonate.

7. A method as claimed in claim 1 in which the recesses are formed by laser machining.

8. A method as claimed in claim 1 in which more than one cover sheet is used and printed with additional conductive tracks to create a multilayer circuit board.

9. Apparatus for carrying out the method defined in claim 1 which includes
a) a hot embossing machine having a former shaped for each particular circuit to be assembled
b) a pick and place machine with standard reel loading of components
c) and a screen printer for printing the conductive ink circuitry or a station for adhering conductive tape or preprinted film.

10. Apparatus as claimed in claim 9 in which the former includes a heating plate and a shaping die.
